(19) United States
(12) Patent Application Publication
(10) Pub. No.: US 2020/0258169 A1
(43) Pub. Date: Aug. 13, 2020

(54) DISTRIBUTED FRAMEWORK FOR SOLVING AND BENCHMARKING SECURITY CONSTRAINED UNIT COMMITMENT WITH WARM START DRIVEN BY DATA ANALYTICS

(71) Applicant: Midcontinent Independent System Operator, Inc., Carmel, IN (US)

(72) Inventors: Yonghong CHEN, Zionsville, IN (US); Fengyu WANG, Carmel, IN (US); Yaming MA, Carmel, IN (US)

(73) Assignee: Midcontinent Independent System Operator, Inc., Carmel, IN (US)

(21) Appl. No.: 16/784,854

(22) Filed: Feb. 7, 2020

Related U.S. Application Data
(60) Provisional application No. 62/802,924, filed on Feb. 8, 2019.

(51) Int. Cl. G06Q 50/06; G06Q 10/04; G06Q 30/02

(52) U.S. Cl. CPC G06Q 50/06; G06Q 30/0201; G06Q 10/04

(57) ABSTRACT

A method may improve commercial optimization solver performance on day ahead security constrained unit commitment through warm start and lazy constraint settings. Data analytics is performed to greatly improve the quality of the initial commitment solution and lazy constraint setting. A distributed optimization framework is provided to take advantage of the diversity from prevalent solvers (GUROBI and CPLEX) under different warm start settings. A systematic distribution profile based benchmarking method is also provided.

### CROSS-REFERENCE TO RELATED APPLICATIONS

This application claims the benefit of the priority date of U.S. provisional application 62/802,924 filed on Feb. 8, 2019 and entitled “A Distributed Framework for Solving and Benchmarking Security Constrained Unit Commitment with Warm Start Driven by Data Analytics,” the content of which is incorporated by reference herein in its entirety.

### TECHNICAL FIELD

The current disclosure pertains to one or more controllers that administer the market for electricity producers and users on an electric power grid. An independent system operator (ISO) is one such controller.

### BACKGROUND

There is a need in solving a security constrained unit commitment (SCUC) problem for electricity market clearing. Its footprint covers fifteen US states and one Canadian province, and contains a total generation capacity of 175 GW. An ISO's network model includes, e.g., over 45,000 buses and 1,400 generation resources, while its market has 2,446 distinct commercial pricing nodes. An ISO may use commercial mixed integer programming (MIP) and linear programming (LP) solver CPLEX to solve SCUC and security constrained economic dispatch (SCED) for market clearing since 2009. MIP solver has greatly improved the solution quality and performance. See R. Bixby et al., “MIP: Theory and Practice-Closing the Gap;” System Modelling and Optimization: Methods, Theory and Applications (2000; vol. 174, p. 19-49) (“Bixby”), which is incorporated by reference in its entirety herein. ISO DA SCUC is a large scale MIP problem. It includes over 50,000 binary variables and about 15,000 transmission constraints across 36 hourly intervals. The time for MIP to reach the tolerance of 0.1% relative gap or $24,000 absolute gap can vary from less than 50 s to over 3600 s. Some computationally challenging SCUC problems may not be able to reach solution tolerance within the preset 20 minutes time limit.

In large scale SCUC problem, MIP solution time is usually driven by two factors 1) large number of binary variables (introducing non-convexity) and 2) large number of security constraints (introducing large number of non-zeros). Therefore, reduction of number of binary variables or security constraints will reduce the computational complexity of large scale SCUC problem. An incremental solving heuristic method was introduced in an ISO's day-ahead market clearing engine to fix binary variables and/or exclude lightly loaded security constraints based on initial SCUC solutions. See Y. Chen et al., “Improving Large Scale Day-Ahead Security Constrained Unit Commitment Performance;” IEEE Transactions on Power Systems (2016; vol. 31:6, p. 4732-4743) (“Chen”), which is incorporated by reference in its entirety herein. This heuristic method significantly improves the solution time for hard cases but it cannot provide global lower bound to justify the optimality. Additionally, to speed up day-ahead market solution time, the inventors and/or others of an ISO have developed alternative optimization methods and researched on advanced mathematical formulations. See Chen; see also Y. Chen et al., “MIP Formulation Improvement for Large Scale Security Constrained Unit Commitment with Configuration Based Combined Cycle Modeling;” Electric Power Systems Research (2017; vol. 148, p. 147-154) (“Chen 2”), which is incorporated by reference in its entirety herein. These efforts result in notable reduction of an ISO's day ahead (DA) market clearing window from 4 hours to 3 hours. See Y. Chen, “Experience and Future R&D on Improving MISO DA Market Clearing Software Performance;” FERC Technical Conference on Increasing Real-Time and Day-Ahead Market Efficiency through Improved Software (2017) (“Chen 3”), which is incorporated by reference in its entirety herein.

See E. Yukseltan et al., “Forecasting Electricity Demand for Turkey: Modeling Periodic Variations and Demand Segregation;” Applied Energy (2017; vol. 193:1, p.28′7-296), which is incorporated by reference in its entirety herein. See also C. Lee et al., “Short-term Load Forecasting Using Lifting Scheme And Arima Models;” Expert Systems with Applications (2011; vol. 38:5, p. 5902-5911), which is incorporated by reference in its entirety herein. See also D. Muttaqi et al., “Short-term Electricity Demand Forecasting Using Autoregressive Based Time Varying Model Incorporating Representative Data Adjustment;” Applied Energy (2017; vol. 205:1, p. 790-801), which is incorporated by reference in its entirety herein. See also C. Guan et al., “Hybrid Kalman Filters for Very Short-Term Load Forecasting and Prediction Interval Estimation;” IEEE Transactions on Power System (2013; vol. 28:4, p. 3806-3817), which is incorporated by reference in its entirety herein. See also S. Li et al., “An Ensemble Approach for Short-Term Load Forecasting by Extreme Learning Machine;” Applied Energy (2016; vol. 170:1, p. 22-29), which is incorporated by reference in its entirety herein. See also Y. Chen et al., “Short-Term Electrical Load Forecasting Using The Support Vector Regression (SVR) Model to Calculate the Demand Response Baseline for Office Buildings;” Applied Energy (2017; vol. 195:1, p. 659-670), which is incorporated by reference in its entirety herein.

### SUMMARY

Systems and methods are disclosed for a distributed framework for solving and benchmarking security constrained unit commitment with warm start driven by data analytics. The method is implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on computer-readable storage device(s).

Motivated by the idea of utilizing existing commitment solution and the incremental solving heuristics, the inventors have researched utilizing existing solutions to accelerate an MIP solver. Providing information of binary variables and security constraints based on initial solution or historical information to MIP solver should speed up the solving process.

There are two primary research areas to utilize the initial solution. The first area is to provide initial commitment solution to MIP solver. Both CPLEX and Gurobi solvers allow feeding in initial binary solutions through “MIP start” setting. In an ISO's day-ahead market clearing process, there are commitment solutions from historical days. Before market starts, operators evaluate day-ahead market based on the best available information to solve “steering cases.” Operators use the security constraint information in the “steering cases” as inputs to better define security constraints and their limits used in the final DA cases.

However, if the initial solution is not feasible, the solvers may not be able to repair and generate feasible solution from it. The feasibility check and repair process is used to quickly turn infeasible solution to feasible for the case to be solved. The inventors developed a feasibility check process to repair solutions from previous days or the “steering cases.” The repaired solution is feasible to the DA case. However, MIP problems are generally not easy to “warm start.” Feeding an initial solution as “MIP start” may not necessarily speed up the solution process.

The second area is to set lightly loaded security constraints as lazy constraints. Lazy constraints are a set of constraints that remain inactive until the solver identifies the needs to add them into the optimization model. Both CPLEX and Gurobi allow setting constraints as “lazy.” However, if the lazy constraint is not set properly, the performance may not be improved. Gurobi has provided three different levels of non-default lazy constraint settings (1, 2, 3) after investigation on hard cases from the ISO. From large set of studies, it works the best to set lightly loaded transmission constraints as lazy=2. Under this setting, all lazy constraints that are violated by a feasible solution will be pulled into the model.

### BRIEF DESCRIPTION OF THE DRAWINGS

The details of particular implementations are set forth in the accompanying drawings and description below. Other features will be apparent from the following description, including the drawings and claims. The drawings, though, are for the purposes of illustration and description only and are not intended as a definition of the limits of the disclosure.

FIG. 1 exemplarily depicts a comparison between CPLEX_Cold and Gurobi_Cold by case, in accordance with one or more embodiments.

FIG. 2 exemplarily depicts a quantile function of PROD model, in accordance with one or more embodiments.

FIG. 3 exemplarily depicts quantile functions of ECC model, in accordance with one or more embodiments.

FIG. 4 exemplarily depicts a comparison of quantile functions between ECC and PROD models, in accordance with one or more embodiments.

FIG. 5 exemplarily depicts a distributed SCUC, in accordance with one or more embodiments.

FIG. 6 exemplarily depicts virtual biddings with changes in offer size and price, in accordance with one or more embodiments.

FIG. 7 illustrates an example of a system in which a power grid market is administered, in accordance with one or more embodiments.

### DETAILED DESCRIPTION

As used throughout this application, the words “is” and “are” are used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

An ISO's DA cases usually include large number of pre-selected transmission constraints called “watch list” constraints. Normally only about 10˜20% of the “watch list” constraints are binding. There is plenty of room to apply lazy constraints.

“MIP start” and “lazy constraint” provide possibilities to send hints from existing solutions to MIP solver. The inventors developed a simple strategy to use previous day commitment solution to generate MIP start and lazy constraint for CPLEX and Gurobi solvers. The inventors define it as “warm start from previous day.” The inventors also selected a large set of historic production cases to evaluate the performance of different solvers and different solution strategies. It's typically unusual for one solve/strategy to be consistently better or worse than another solver/strategy. A performance distribution profile based performance evaluation method is therefore provided. The current disclosure presents the performance for both CPLEX and Gurobi under the two strategies: “cold start” and “warm start from previous day.” The performance benchmark method is also provided.

Each solver under each strategy may work well for a subset of cases. The inventors have identified that selecting the best solution from multiple solvers and/or strategy can result in significant improvement. Consequently, a distributed framework is provided and the performance is compared to other approaches.

“Steering case” usually includes better information than previous day. However, “steering case” only takes a snapshot of offers and load forecasts before the final offers are all submitted to the market. Therefore, “steering case” may not capture the final generation or virtual offers. Data analytics can be applied to improve the inputs and solution quality of “steering case.” Data analytics on virtual biddings show that a significant percentage of the final virtual biddings are similar across days even though many of them may be submitted after the snapshot of the “steering case” is taken. Historical virtual biddings can be used to improve the “steering case” virtual inputs. “Steering case” generation capacity data could be different from the final day-ahead market case and data analytics can also be used to estimate the final generation capacity offer. The current disclosure discusses the improvement from data analytics.

This disclosure provides methods to improve commercial optimization solver performance on day ahead security constrained unit commitment through warm start and lazy constraint settings. Data analytics is performed to greatly improve the quality of the initial commitment solution and lazy constraint setting. A distributed optimization framework is provided to take advantage of the diversity from prevalent solvers (GUROBI and CPLEX) under different warm start settings. A systematic distribution profile based benchmarking method is also provided. The current disclosure provides the use of pre-existing commitment solution to provide hints (MIP start and lazy constraint) to SCUC. A distributed solving framework is provided and studied to maximize the strength from multiple solvers and solution strategies.

In this disclosure, the distributed framework for solving SCUC is provided to take advantage of the diversity of the commercial solver performance. A distribution profile based performance benchmark method is provided to reflect the statistic distribution of difference solution methods or SCUC models. Historical commitment data is used to warm start MIP solvers through “MIP start” and lazy constraint settings. Historical data is also used to improve the steering case solutions that can be used to further improve the warm start of the final DA cases.

A systematic distribution profile base performance evaluation method is provided to evaluate MIP performance for market clearing production application.

This framework allows improving hints generation through historic data analytics. The work of improving “steering case” through historic data analysis and then generating better hints with the improved solution is provided.

In an aspect, a system or method for operating an electrical power grid by a controller includes the following steps: providing, by the controller, one or more mixed integer programming (MIP) solvers for solving security constrained unit commitment (SCUC) and/or security constrained economic dispatch (SCED) for market clearing; and performing data analytics to improve the quality of initial commitment solution and/or lazy constraint setting for the solver(s).

In another aspect, a system or method for operating an electrical power grid by a controller includes the following steps: providing, by the controller, one or more mixed integer programming (MIP) solvers for solving SCUC and/or SCED for market clearing; and utilizing previous day commitment solution to generate warm start and lazy constraints for the solver(s).

In yet another aspect, a system or method for operating an electrical power grid by a controller includes the following steps: providing, by the controller, one or more mixed integer programming (MIP) solvers for solving SCUC and/or SCED for market clearing; improving “steering case” solution through historic data analysis; and providing better hints to the solvers with the improved solution.

In a detailed embodiment of one or more of the above aspects (or any combination of the above aspects), the method further includes providing a distributed solving framework to select among multiple solver(s) and/or solution strategies. Alternatively, or in addition, the solver(s) includes CPLEX and Gurobi solvers and the framework to include any other solvers. Alternatively, or in addition, the method further includes producing a performance distribution profile and a performance measurement approach to reflect the statistic distribution of the solving time for the purpose of systematical comparison of the performance from different solvers and solution strategies. Alternatively, or in addition, the combination of solver and solution strategy include: (a) CPLEX “cold start”: (b) CPLEX “warm start from previous day”; (c) Gurobi “cold start”, (d) Gurobi “warm start from previous day.”; (e) CPLEX “warm start from steering cases” and (f) Gurobi “warm start from steering cases.” Alternatively, or in addition, the plurality of solvers and solution approaches are solved in parallel using a distributed framework. Alternatively, or in addition, the method includes receiving from a user selections of different solver(s) and/or different initial solution(s) to solve the problem in parallel as a simple implementation version of the distributed framework. Alternatively or in addition, the system includes a distributed architecture in future market system to configure and execute the parallel sessions with different solver(s) and/or different initial solution(s) and/or solution strategies.

Herein is described commercial solver performance and a performance benchmark.

There are many inputs to production SCUC and it is usually rare to see one solver or one approach consistently dominate the other. Hence, it's not straight forward to claim one scenario is certain times faster than the other. Here the inventors define scenario as a unique combination of solver, solving method, and SCUC formulation.

The inventors have compared the scenarios from the following combinations of options:

TABLE 1

| | OPTION 1 | OPTION 2 |
|---|---|---|
| SOLVER | CPLEX 12.6 | Gurobi 7.5 |
| | (CPLEX) | (Gurobi) |
| SOLUTION | Cold Start | Warm Start from |
| METHOD | | previous day |
| | | (Warm Start 1) |
| SCUC | Production DA | DA SCUC with Enhanced |
| FORMULATION | SCUC (PROD) | Combined Cycle (ECC) |

For example, scenario 1 can be: “solver—CPLEX, solution method—cold start, SCUC formulation—production DA SCUC”, scenario 2 can be “solver—Gurobi, solution method—Warm Start 1, SCUC formulation—SCUC with ECC.”

In “Warm Start 1”, the inventors first repair commitment solution from previous day DA solution to be a feasible solution for current day DA case. The method for solution repair can be found in. See Chen 3. The inventors then fix binary variables at the repaired initial solution to solve SCED. It's a linear programming (LP) problem. Based on the LP solution, the inventors set all transmission constraints below 80% loading as lazy. The inventors also set “MIP start” with this initial feasible solution. The solvers will start with setting binary variables at the “MIP start” values.

An ISO's current production DA SCUC reflects combined cycle plants as an aggregation. The Enhanced Combined Cycle formulation refers to the configuration based combined cycle modeling. See Chen 2. The disclosed approach improved mathematical formulations and led to the possibility of implementation. A hybrid configuration and component based model was proposed. See C. Dai et al. “A Configuration-Component Based Hybrid Model for Combined-Cycle Units in MISO Day-Ahead Market;” IEEE Transactions on Power Systems (2018) (“Dai”), which is incorporated by reference in its entirety herein. The inventors evaluated the ECC formulation performance under various solver and solution strategies.

The inventors selected 72 DA cases from an ISO production. The time for solving MIP under production SCUC formulation ranges from 100 s to 1177 s. The inventors define it as the base scenario:

S1:“Production_DA_SCUC/CPLEX/Cold_Start.”

The inventors then ran the 72 cases with the following 3 different scenarios:

S2: “Production_DA_SCUC/CPLEX/Warm_Start_1”

S3: “Production_DA_SCUC/Gurobi/Cold_Start”

S4: “Production_DA_SCUC/Gurobi/Warm_Start_1”

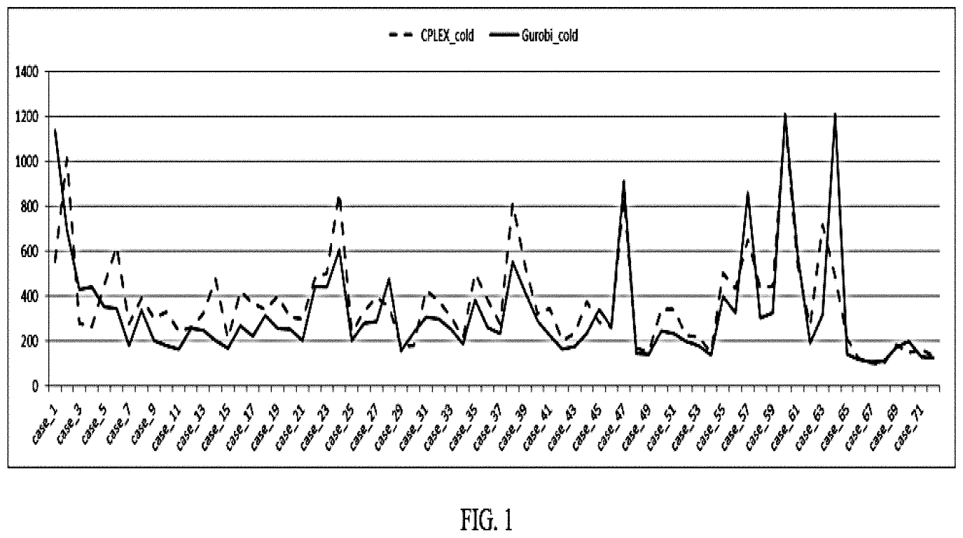

The inventors observed diversity between CPLEX and Gurobi. Cases that are hard for CPLEX may be easy for Gurobi and vise verse. FIG. 1 shows the solving times of CPLEX_cold and Gurobi_cold for each of the 72 cases. That is, FIG. 1 exemplarily depicts a comparison between CPLEX_Cold and Gurobi_Cold by case. It is not straight forward to measure the performance of the two solvers. Given the production on-time posting target, the inventors proposed a distribution profile based performance measurement method.

Typical performance benchmark methods compare solver performance on a set of cases. A performance profile based method was proposed for evaluating the performance of two or more solvers on a given set of test problems. See E. Dolan et al., “Benchmarking Optimization Software with Performance Profile,” Mathematical Programming (2001) (“Dolan”), which is incorporated by reference in its entirety herein. The profile can show graphically how each solver performs relative to the best time from all solvers. However, it provides neither an index nor a confidence level of the performance differences.

For the application on market clearing problem, it is more important to understand the overall distribution of solution times. The inventors use percentage (e.g., 97%) of on-time posting market solution as one of the measurements of DA performance. Solution time and quality of SCUC have direct impact on the on-time posting rate. The inventors propose to use a distribution profile based method to provide performance improvement ratio with level of confidence.

For each of the solving approaches, after solving the 72 sample cases, the inventors derive the quantile function of the solving time. Quantile function is the generalized inverse cumulative distribution function. Assume the solving time of scenario j is a random variable Xⱼ with cumulative the following distribution function:

Fⱼ(t)=P(Xⱼ≤t)

The quantile function (i.e., generalized inverse distribution function) is:

Tⱼ(p)=inf{t∈R: Fⱼ(t)≤p} for p∈[0,1]

The quantile function is a good way to show the performance distribution graphically. The quantile functions of two marginal distributions are used to evaluate the effectiveness of depression treatment. See R. R. Wilcox, “Comparing Two Dependent Groups Via Quantiles;” Journal of Applied Statistics (2012; vol. 39) (“Wilcox”), which is incorporated by reference in its entirety herein. Qqj is the qth quantile corresponding to the jth marginal distribution. Then a goal of interest is testing H0: Qq1=Qq2 or computing a 1-α confidence interval for Qq1-Qq2. This method is used to test the hypophysis. However, it can't tell how much times of improvement. For the purpose of evaluating the performance of two solving approaches, the inventors want to know how much one solving approach is faster than the other. Therefore, the inventors modified the method to compare the ratio of the two quantile functions for scenarios i and j by defining:

Rᵢⱼ(k, p)=kTᵢ(p)−Tⱼ(p) for p∈[0,1]

where k is the speedup ratio of scenario j to scenario i.
Consider Rᵢⱼ(k,p) as the random variable. The goal is to test the hypophysis or a 1-α confidence interval for:

H(k): kTᵢ(p)−Tⱼ(p)>0

Here the inventors use α=0.03 to be consistent with 97% on-time posting requirement. Based on central limit theorem, if the sample size is large enough, the distribution of the average will be closely approximated by a normal distribution. The inventors may use one side t-test to test the hypophysis. See J. L. Devore, “Probability and Statistics for Engineering and the Sciences” (1982) (“Devore”), which is incorporated by reference in its entirety herein.

Assume the true mean of Rᵢⱼ(k,p) is μ_{i,jk}. The inventors propose to solve for the smallest k such that p(μ_{i,j,k}>0)>1−0.03 or p(μ_{i,j,k}<0)<0.03. Under this k, the true mean of Rᵢⱼ(k, p)=kTᵢ(p)−Tⱼ(p) is larger than 0 with 97% confidence. The inventors define it as:

kⱼᵢ^{α}=inf{k|p(μ_{ij,k}<0)≤α}

The inventors use the value kⱼᵢ^{α} to represent the performance improvement ratio between scenario j and i. It can better reflect the statistic distribution than the sample mean.

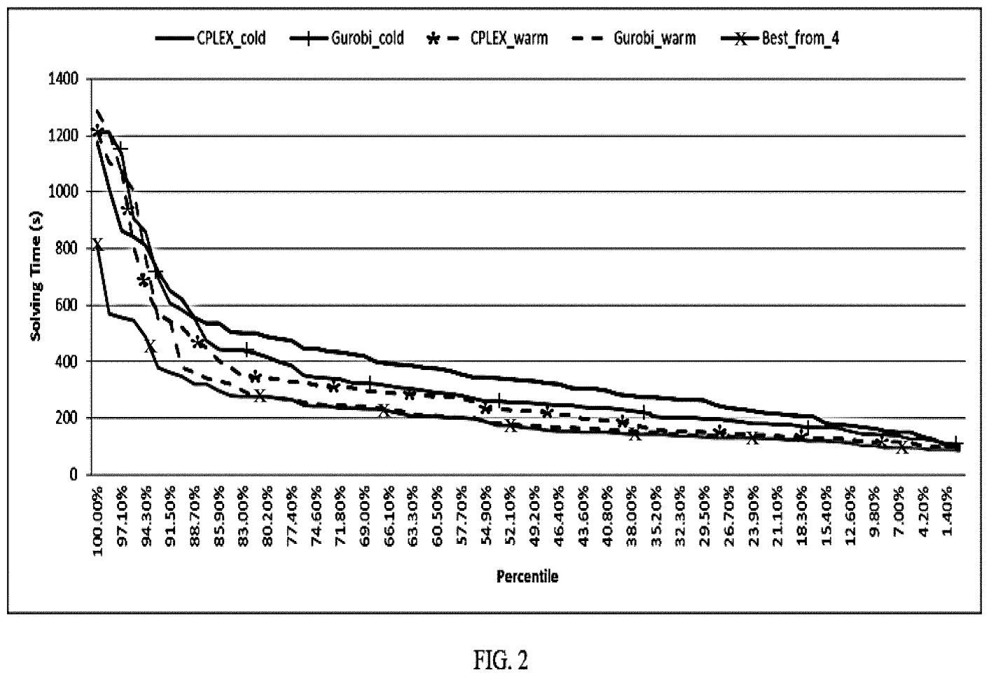

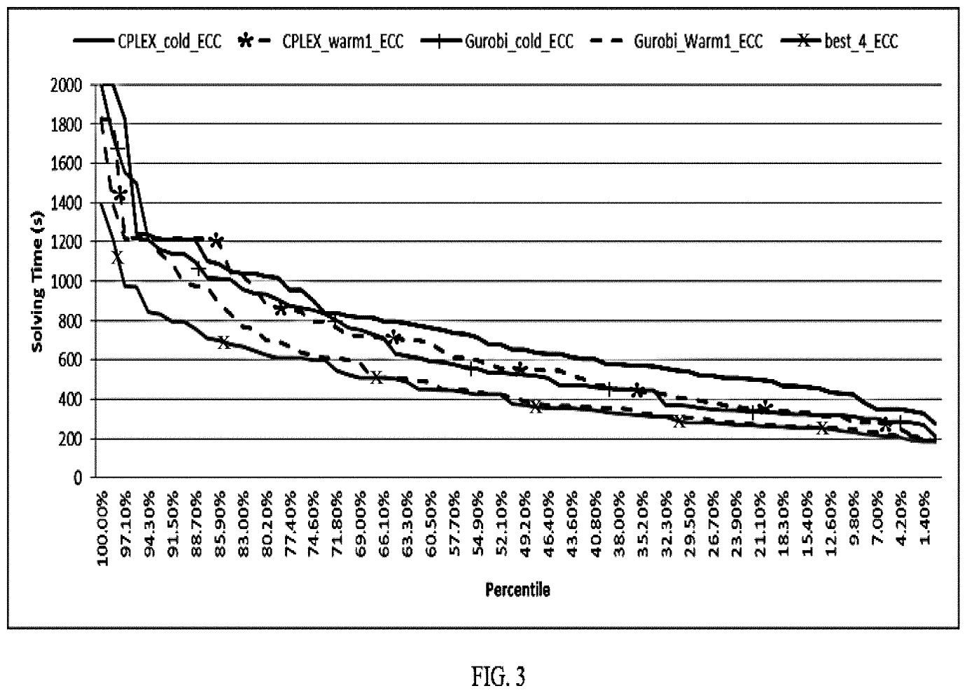

In Table 2, the inventors compare the performance of Gurobi_Cold, CPLEX_Warm1, Gurobi_Warm1 to CPLEX_Cold for PROD model. Similar comparison is shown for ECC model in Table 3. In general, the inventors observe that the performance improvement ratio calculated from sample mean can be overestimate of the improvement. Both indices show similar trend. Gurobi_Warm1 performs the best among the 4 methods under both SCUC models. The initial solution for warm start is from repaired previous day commitment. It's in general not a very close initial solution. From the quantile functions shown in FIGS. 2-3, warm start may sometimes cause longer solving time on the high percentile range. That is, FIG. 2 exemplarily depicts a quantile function of PROD model. And FIG. 3 exemplarily depicts quantile functions of ECC model.

Herein described is a risk index. The index developed above can reflect the average performance improvement. However, it's also important to reflect the risk of not able to solve the cases within the time limit. Hence, a risk factor is also developed.

Production DA SCUC solves with two stages: the first stage uses 1200 s time limit, 0.1% relative MIP gap and $24000 absolute MIP gap as the stopping criteria. If it reaches 1200 s and the MIP relative gap is over 3%, it will run the second stage for another 600 s. If the gap at the end of the second stage (i.e., 1800 s) is large, other backup methods will be used. See Chen. So far all PROD model can solve within the first stage. However, with the ECC model, some cases may require longer solving time. With that, the inventors developed the risk index to compare the performance on hard cases. The risk index includes three components:

1) N1: Number of cases stopped at 1200 s

2) N2: Number of cases stopped between 1200 s and 1800 s

3) N3: Number of cases with large gap at 1800 s

The risk index is defined as: R=α1·N1+α2·N2+α3·N3. The inventors use α1=1, α2=3 and α3=100.

In PROD model, warm start may introduce slightly higher risk factor if the initial commitment is not very good. This can be improved through improved initial commitment as shown below. Gurobi solver has slightly high risk factor. The main reason is that Gurobi solver hasn't been used in production extensively. It can be improved through better tuning.

In ECC mode, CPLEX_Cold has three cases solved with over 90% MIP gap at 1800 s. It introduces great risk. Gurobi_Cold has one case with such high risk. With warm start, both CPLEX and Gurobi can avoid high risk cases. Gurobi_Warm1 has the lowest risk factor.

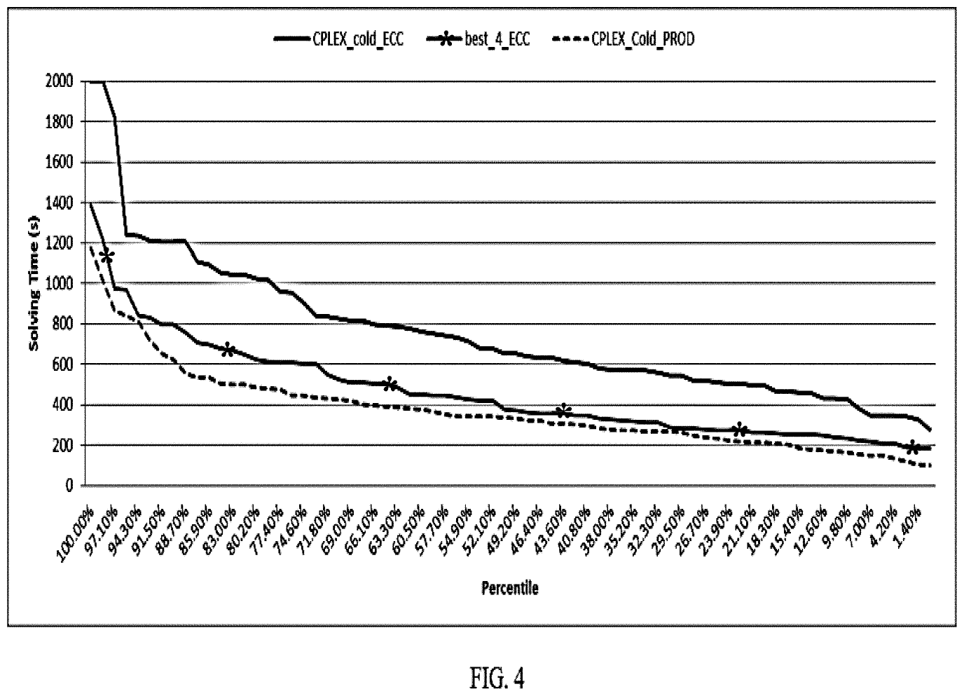

In Table 5 and FIG. 4, CPLEX_Cold ECC is compared to CPLEX_Cold_PROD. With CPLEX_Cold, ECC model requires much longer solving time with

$$\frac{\overline{{x}_{6}}}{\overline{{x}_{1}}} = 2.16$$

and k₆₁^{0.03}=2.29. The risk index of CPLEX_Cold_ECC is very high at 306. FIG. 4 exemplarily depicts a comparison of quantile functions between ECC and PROD models.

Table 2, below, shows a comparison of PROD Model. And Table 3, below Table 2, shows a comparison of ECC Model.

TABLE 2

| | SCENARIO | | | | |
|---|---|---|---|---|---|
| | 1 | 2 | 3 | 4 | 5 |
| | METHOD | | | | |
| | CPLEX | GUROBI | CPLEX | GUROBI | BEST |
| | COLD | COLD | WARM | WARM | OF |
| | START | START | START | START | FOUR |
| \ddot{x}ⱼ | 371.99 | 327.92 | 286.00 | 255.64 | 211.36 |
| \ddot{x}ⱼ/x̅₁̅ | 1.00 | 0.88 | 0.77 | 0.69 | 0.57 |
| kⱼ₁^{0.03} | | 0.92 | 0.81 | 0.76 | 0.58 |
| # of Cases at 1200s | 0 | 2 | 1 | 2 | 0 |
| (x1) | | | | | |
| # of Cases between | 0 | 0 | 0 | 0 | 0 |
| 1200s and 1800s | | | | | |
| # of Cases with | 0 | 0 | 0 | 0 | 0 |
| Large Gap at 1800s | | | | | |
| (x100) | | | | | |
| Risk Index | 0 | 2 | 1 | 2 | 0 |

TABLE 3

| | SCENARIO | | | | |
|---|---|---|---|---|---|
| | 6 | 7 | 8 | 9 | 10 |
| | METHOD | | | | |
| | CPLEX | GUROBI | CPLEX | GUROBI | BEST |
| | COLD | COLD | WARM | WARM | OF |
| | START | START | START | START | FOUR |
| \ddot{x}ⱼ | 802.06 | 655.82 | 651.63 | 521.23 | 460.30 |
| \ddot{x}ⱼ/x̅₁̅ | 1.00 | 0.82 | 0.81 | 0.65 | 0.57 |
| kⱼ₁^{0.03} | | 0.87 | 0.88 | 0.70 | 0.62 |
| # of Cases at 1200s | 6 | 1 | 8 | 5 | 2 |
| (x1) | | | | | |
| # of Cases between | 0 | 3 | 2 | 0 | 0 |
| 1200s and 1800s | | | | | |
| # of Cases with | 3 | 1 | 0 | 0 | 0 |
| Large Gap at 1800s | | | | | |
| (x100) | | | | | |
| Risk Index | 306 | 110 | 14 | 5 | 2 |

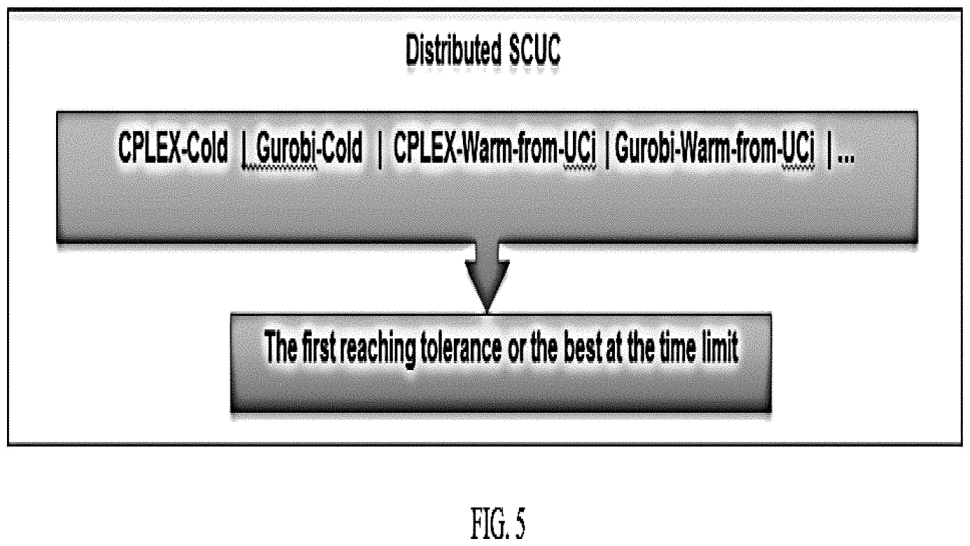

Herein described is a distributed framework. One observation on different solving methods is that the solvers have some diversity. In FIG. 1, the inventors can see that hard cases for Gurobi may be easy for CPLEX and vise verse. It motivated us to propose the distributed framework to solve the problem with multiple solvers and/or strategies simultaneously and retrieve the best solution. In this frame work, the inventors can solve CPLEX_Cold, Gurobi_Cold, CPLEX_Warm1 and Gurobi_Warm1 in parallel. The one that reaches MIP gap tolerance first or has the best MIP gap at time limit is the final solution as shown in FIG. 5. In Tables 2-3 and FIGS. 2-4, the scenario Best_4 is the result from applying this strategy for each case. It can greatly reduce the solving time and the risk index.

In FIG. 4, the distribution profile for best_4_ECC is much closer to CPLEX_cold_PROD. In Table 5, the performance and risk indices of Best_4_ECC is much better than the indices of CPLEX_Cold_ECC.

The distributed framework also allows applying data analytics to warm start with better initial commitment solutions. The inventors may solve SCUC with multiple warm starts. The next section shows some examples of improvement through better warm start.

Currently in ISO production, operators can start multiple cases at the same time. An embodiment of the distributed solution process is to allow the operators to select different solvers and/or initial solutions. Another embodiment is to organize multiple solution approaches in an automated way. This embodiment may require increasing the number of servers. Given the overall benefit from the enhanced solution and reduced risk, this investment is usually justifiable. This framework also allows plugging in other new solution approaches. FIG. 5 exemplarily depicts a distributed SCUC.

Herein is described an improvement through better warm start and lazy constraints pool. The solving performance of commercial solvers on large-scale MIP problems could be improved by providing good warm start and/or lazy constraints pool. The solution time of SCUC may be greatly reduced when the solvers start from a set of unit commitment solution that is close to the final solution. Lazy constraints can also help reduce the problem size and improve the solution time. However, poor quality of lazy constraints pool would result in adding back too many constraints to the model and may sometimes slow down the performance. Therefore, good quality of warm start and lazy constraints pool definition may improve SCUC solution time. An ISO's DA operators perform pre-market study, i.e., the steering case to evaluate the constraints congestion and limits. The steering case solution can help define the warm start and lazy constraints pool. To improve the warm start and lazy constraints pool, it is desirable to improve the steering case accuracy. After analysis on historical data, the inventors identified two major factors driving the steering case inaccurate, 1) Virtual biddings 2) Generators maximum output capacity. This section focuses on improving the steering case accuracy and use statistical method to compare the numerical results.

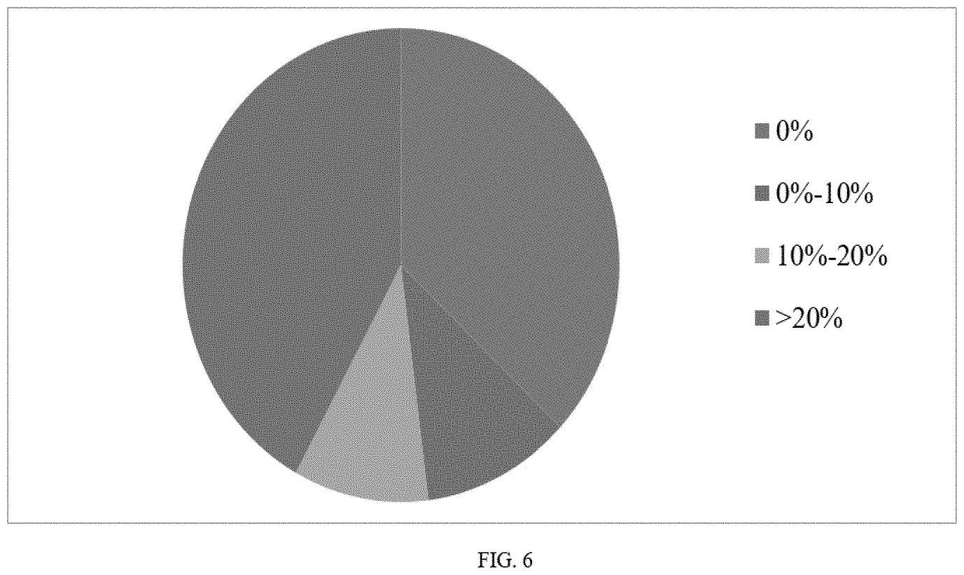

Herein is described an improvement of virtual offers. Virtual offers input for “steering cases” can be improved based on historical data. Based on the analysis of one year historical data, 37% virtual biddings have 0% change in their offer size and price, 11% virtual biddings have 0%-10% change in their offer size and price, and 10% virtual biddings have 10%-20% change in their offer size and price, and 42% virtual biddings have more than 20% change in the offer size and price. The percentage of virtual biddings by changes in offer size and price is demonstrated in FIG. 6. That is, FIG. 6 exemplarily depicts virtual biddings with changes in offer size and price.

By improving “steering case” model, better lazy constraints pool can be defined for the final DA case and fewer lazy constraints are expected to be added back to the model by the solver. In an embodiment, if a constraint's flow is below 70% loading in the steering case, the constraint is set as lazy constraint. With improved steering case, the power flow information is closer to the actual day-ahead market case, and thus the lazy constraints pool is better defined. Four scenarios are compared, CPLEX with the original steering case, CPLEX with the enhanced steering case, Gurobi with the original steering case, and Gurobi with the enhanced steering case.

From Table 4, average number of lazy constraints added back to the model based on the enhanced “steering case” is significantly reduced compared to the lazy constraint setting based on the original “steering case.” Table 4 shows that under lazy constraint setting from original “steering cases”, CPLEX adds back 147 lazy constraints while under lazy constraint setting from enhanced “steering case”, CPLEX only adds back 70 lazy constraints. Similarly, the number of lazy constraints added back to the model based on lazy constraint from enhanced “steering case” is significantly reduced compared with lazy constraint from the original “steering case” in GUROBI solver. The average number of lazy constraint from original “steering case” added back by Gurobi is 203 while with enhanced “steering case”, it only adds back 96 lazy constraints. Each scenario includes 42 sample production cases.

In Table 4, the average solution times for the four scenarios are 394s, 348s, 249s and 237s respectively. Scenario 11 is the base “CPLEX starting with the original steering case.” The ratio between scenario j and scenario 11 is x̅ⱼ/x̅₁̅₁̅.With enhanced steering case, CPLEX only takes 0.88 times solution time of the original steering case CPLEX on average. Original steering case Gurobi and enhanced steering case Gurobi can improve to 63% and 60% of the base scenario 11 solving time on average. 1−kⱼ₁^{0.03} represents the improvement of a solving approaches based on 97% confidence interval t-test. CPLEX with enhanced steering case improves around 10% computational performance comparing with the base scenario 11. Gurobi with the original steering case improves 29% computational performance while Gurobi with enhanced steering case improves 32%.

One of the biggest contributors to the difference between the “steering case” and the final DA case is the economic maximum limit of units. Currently, “steering case” uses the offer from the same day of last week if the energy offer of a unit is not available. However, this logic may not be the best to estimate the economic maximum limit. It may be desirable to provide logic to better estimate the economic maximum limit of each unit for the “steering case” based upon economic max data for each unit.

Table 4, below, shows a comparison of lazy constraints model. And Table 5, below Table 4, shows a comparison of ECC model to CPLEX_Cold_PROD.

TABLE 4

| | SCENARIO | | | |
|---|---|---|---|---|
| | 11 | 12 | 13 | 14 |
| | Method | | | |
| | Original | Enhanced | Original | Enhanced |
| | CPLEX | CPLEX | Gurobi | Gurobi |
| \ddot{x}ⱼ | 394.91 | 348.28 | 248.94 | 236.81 |
| \ddot{x}ⱼ/x̅₁̅₁̅ | 1 | 0.88 | 0.63 | 0.60 |
| kⱼ₁^{0.03} | | 0.90 | 0.71 | 0.68 |
| Average # of | 147 | 70 | 203 | 96 |
| Added Back Lazy | | | | |
| Constraints | | | | |

TABLE 5

| | SCENARIO | | |
|---|---|---|---|
| | 1 | 6 | 10 |
| | Method | | |
| | CPLEX_Cold_PROD | CPLEX_Cold_ECC | Best_4_ECC |
| \ddot{x}ⱼ | 371.99 | 802.06 | 460.30 |
| \ddot{x}ⱼ/x̅₁̅₁̅ | 1.00 | 2.16 | 1.24 |
| kⱼ₁^{0.03} | | 2.29 | 1.26 |
| # of cases at 1200s (X1) | 0 | 6 | 2 |
| # of cases between 1200s | 0 | 0 | 0 |
| and 1800s (X3) | | | |
| # of cases with large gap | 0 | 3 | 0 |
| at 1800s (X100) | | | |
| Risk Index | 0 | 306 | 2 |

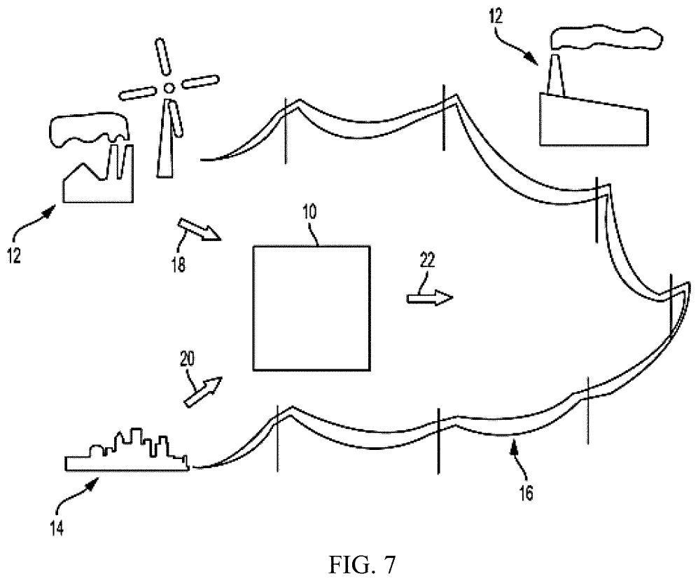

Referring to FIG. 7, a system is disclosed, including exemplary controller 10 that administers the market for electricity producers 12 and users 14 on electric power grid 16. Some exemplary functions of controller 1l include monitoring energy transfers on the transmission system, scheduling transmission service, managing power congestion, operating DA and RT energy and operating reserves (OR) markets, and regional transmission planning. Certain of electricity producers 12 may be able to offer combined cycle configurations, which may utilize a combination of physical power producing units such as one or more combustion turbines (CT), steam turbines (ST), DBs, combined cycle, pump storage, batteries, nuclear, hydro (pumped), wind, utility or rooftop photovoltaic (PV), and the like. In some embodiments, data relating to electrical power grid 16 may be obtained 18, 20 from electricity producers 12 and users 14 and transmitted 22 to the same. Controller 10 includes one or more computer systems specially configured to perform the stated operations set forth herein.

Several embodiments of the invention are specifically illustrated and/or described herein. However, it will be appreciated that modifications and variations are contemplated and within the purview of the appended claims.

What is claimed is:

1. A method for operating an electrical power grid where the electrical power grid includes an electrical power grid, a plurality of power generation participants providing electric power to the electrical power grid, a plurality of consumers drawing electrical power from the electrical power grid, and a controller that administers the market for the power generation participants and the consumers on the electrical power grid, the method including:
providing, by the controller, one or more mixed integer programming (MIP) solvers for solving security constrained unit commitment (SCUC) and/or security constrained economic dispatch (SCED) for market clearing; and
performing data analytics to improve quality of an initial commitment solution and/or a lazy constraint setting for the one or more solvers.

2. The method of claim 1, further comprising:
providing a distributed solving framework to select among a plurality of the solvers and/or solution strategies.

3. The method of claim 1, wherein the one or more solvers include CPLEX and Gurobi solvers.

4. The method of claim 1, further comprising:
producing performance distribution profiles for the plurality of solvers; and
comparing the profiles using a distributed framework.

5. The method of claim 4, wherein the profiles include:
CPLEX cold start;
CPLEX warm start from previous day;
Gurobi cold start; and
Gurobi warm start from a previous day.

6. The method of claim 1, wherein the plurality of solvers are solved in parallel using a distributed framework.

7. The method of claim 1, further comprising:
receiving from a user selections of one or more different solvers and/or one or more different initial solutions to compare utilizing a distributed framework.

8. The method of claim 1, further comprising:
automating selections of one or more different solvers and/or of one or more different initial solutions to compare utilizing a distributed framework.

9. A controller for administering a market for power generation participants and consumers on an electrical power grid, the controller performing the method of claim 1.

10. The method of claim 1, further comprising:
utilizing previous day commitment solution to generate warm start and lazy constraints for the one or more solvers.

11. The method of claim 1, further comprising:
improving a steering case in the one or more solvers through historic data analysis; and
providing better hints with the improved solution.

12. A method for operating an electrical power grid where the electrical power grid includes an electrical power grid, a plurality of power generation participants providing electric power to the electrical power grid, a plurality of consumers drawing electrical power from the electrical power grid, and a controller that administers the market for the power generation participants and the consumers on the electrical power grid, the method including:
providing, by the controller, one or more mixed integer programming (MIP) solvers for solving SCUC and/or SCED for market clearing; and
utilizing previous day commitment solution to generate warm start and lazy constraints for the one or more solvers.

13. The method of claim 12, further comprising:
performing data analytics to improve quality of an initial commitment solution and/or a lazy constraint setting for the one or more solvers.

14. The method of claim 12, further comprising:
improving a steering case in the one or more solvers through historic data analysis; and
providing better hints with the improved solution.

15. A method for operating an electrical power grid where the electrical power grid includes an electrical power grid, a plurality of power generation participants providing electric power to the electrical power grid, a plurality of consumers drawing electrical power from the electrical power grid, and a controller that administers the market for the power generation participants and the consumers on the electrical power grid, the method including:
providing, by the controller, one or more mixed integer programming (MIP) solvers for solving SCUC and/or SCED for market clearing;
improving a steering case in the one or more solvers through historic data analysis; and
providing better hints with the improved solution.

16. The method of claim 15, further comprising:
performing data analytics to improve quality of an initial commitment solution and/or a lazy constraint setting for the one or more solvers.

17. The method of claim 15, further comprising:
utilizing previous day commitment solution to generate warm start and lazy constraints for the one or more solvers.
